(19) United States
(12) Patent Application Publication
(10) Pub. No.: US 2004/0047558 A1
(43) Pub. Date: Mar. 11, 2004

(54) Optical module

(76) Inventors: Yoshihide Yasuda, Osaka-shi (JP); Yoshiro Sato, Osaka-shi (JP); Minoru Taniyama, Osaka-shi (JP); Yasufumi Muto, Osaka-shi (JP)

Correspondence Address: POSZ & BETHARDS, PLC, 11250 ROGER BACON DRIVE, SUITE 10, RESTON, VA, 20190, US

(21) Appl. No.: 10/656,327

(22) Filed: Sep. 8, 2003

(30) Foreign Application Priority Data
Sep. 10, 2002 (JP) 2002-264699

(51) Int. Cl. G02B 6/26; G02B 6/42; G02B 6/32

(52) U.S. Cl. 385/33; 385/31

(57) ABSTRACT

An optical fiber array has optical fibers and an outgoing end surface. Each optical fiber has a central axis of the optical fiber. A lens array has microlenses. The lens array includes an incoming end surface, which faces the outgoing end surface of the optical fiber array, and an outgoing end surface, which sends out light transmitted through each microlens. Each microlens has an optical axis. The outgoing end surface of the optical fiber array is inclined with respect to the central axis of each optical fiber. The incoming end surface of the lens array is inclined with respect to the optical axis of each microlens. The relative position of the optical fiber array and the lens array is adjusted such that the inclination angle of the outgoing light sent out from the outgoing end surface of the lens array with respect to the optical axis of each microlens becomes an optimal angle.

### BACKGROUND OF THE INVENTION

The present invention relates to an optical module that includes an optical fiber array and a lens array, and is formed as a collimator or a collimator array.

Such an optical module is used in an optical communication field as a collimator optical device by using a pair of the optical modules. In the collimator optical device, an optical function element, such as an optical filter, an optical isolator, an optical switch, and an optical modulator, is inserted between the pair of the above mentioned optical modules. The collimator optical device applies a predetermined effect on light that is transmitted through an optical fiber on an incoming side, and couples the light to an optical fiber on an outgoing side.

In the prior art, an optical module has been proposed as shown in FIGS. 8 and 9. The optical module is formed as a collimator array and includes an optical fiber array 21, which retains optical fibers 20 arranged in a line, and a lens array 23, which includes microlenses 22 arranged in a line. (For example, Japanese Laid-Open Patent Publication 2001-305376). The optical fiber array 21 has a capillary 24, which retains the optical fibers 20 as a unit. The lens array 23 is a flat microlens array that has a transparent lens substrate 25. The microlenses 22 are formed on the right end surface of the lens substrate 25. The positions of the optical fiber array 21 and the lens array 23 are determined such that the distance between a fiber outgoing end surface 26 and the microlenses 22 is substantially equal to a focal distance f of the microlenses 22, which is a predetermined lens to optical fiber distance L.

An optical module shown in FIGS. 10 and 11 is substantially the same as the optical module shown in FIGS. 8 and 9 except that the surface of the lens substrate 25 on which the microlenses 22 are arranged faces the fiber outgoing end surface 26. In the optical module shown in FIGS. 10 and 11, the positions of the optical fiber array 21 and the lens array 23 are determined such that the distance between the fiber outgoing end surface 26 and the microlenses 22 is equal to the predetermined lens to optical fiber distance L.

FIG. 12 shows a conventional optical module that includes a single core capillary 32, which retains an optical fiber 31, and a gradient index rod lens 33. The optical module of FIG. 12 is formed as a collimator (single collimator). In the optical module shown in FIG. 12, a fiber outgoing end surface 34 and a lens incoming end surface 35 of the rod lens 33 are polished to have the same inclination angle in order to reduce reflected return light at the fiber outgoing end surface 34 and the lens incoming end surface 35. Such an optical module has been proposed in, for example, Japanese Laid-Open Patent Publication No. 2002-196182. In such an optical module, it has been proposed to reduce the reflected return light at a lens outgoing end surface 36 of the rod lens 33 by tilting an outgoing light from the rod lens 33 with respect to an optical axis of the rod lens 33. The reflected return light refers to light that is reflected by the fiber outgoing end surface 34 of the optical fiber 31, the lens incoming end surface 35 of the rod lens 33, and the lens outgoing end surface 36, and that returns to the optical fiber 31 on the incoming side

In the optical module shown in FIGS. 8 and 9, the reflected return light is generated at the fiber outgoing end surface 26, the lens incoming end surface 27 of the lens substrate 25, and the lens outgoing end surface 28 of the lens substrate 25. Further, in the optical module shown in FIGS. 8 and 9, the capillary 24 and the lens substrate 25 are rectangular. This increases the reflected return light. If the reflected return light that occurs at the above mentioned three surfaces returns to a light source, such as a semiconductor laser, through the optical fibers 20 on the incoming side, the oscillation of the semiconductor laser becomes unstable. Therefore, it is required to minimize the reflected return light of each optical module. When similar optical modules are arranged in multiple stages, the reflected return light caused in each optical module increases as the number of stages of the optical modules is increased. Thus, the necessity to reduce the reflected return light is further increased.

In the optical module shown in FIGS. 10 and 11, the reflected return light is also caused at the fiber outgoing end surface 26, a lens incoming end surface 29 of the lens substrate 25, and a lens outgoing end surface 30 of the lens substrate 25. Therefore, in the optical module of FIGS. 10 and 11, it is also required to minimize the reflected return light of each optical module.

In the optical module shown in FIG. 12, when the outgoing light from the rod lens 33 is tilted with respect to the optical axis of the rod lens 33 to reduce the reflected return light at the lens outgoing end surface 36, the following problems might be caused. Since the outgoing light from the rod lens 33 is tilted with respect to the optical axis, a similar optical module or another optical part needs to be attached to the optical module at an angle. This increases the number of parts and takes a lot of trouble in the adjustment for mounting the similar optical module or another optical part. Further, if the outgoing light is tilted with respect to the optical axis at a large angle, a large space is required for arranging another optical part.

### SUMMARY OF THE INVENTION

Accordingly, it is an objective of the present invention to provide an optical module that reduces reflected return light. Another objective of the present invention is to provide an optical module that reduces reflected return light while reducing number of parts, procedures for adjustment, and a space required for mounting, for example, optical parts.

To achieve the above objective, the present invention provides an optical module, which includes an optical fiber array and a lens array. The optical fiber array has at least one optical fiber and an outgoing end surface. The optical fiber includes a central axis of the optical fiber. The lens array has at least one microlens. The lens array includes an incoming end surface, which faces the outgoing end surface of the optical fiber array, and an outgoing end surface, which sends out a light that is transmitted through the microlens. The microlens has an optical axis. The outgoing end surface of the optical fiber array is formed to be inclined with respect to the central axis of the optical fiber. The incoming end surface of the lens array is formed to be inclined with respect to the optical axis of the microlens. The relative position of the optical fiber array and the lens array is adjusted such that an inclination angle of the outgoing light sent out from the outgoing end surface of the lens array with respect to the optical axis of the microlens becomes an optimal angle.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a side view illustrating an optical module according to a first embodiment of the present invention;

FIG. 2 is a plan view illustrating the optical module shown in FIG. 1;

FIG. 3 is a side view illustrating an optical system used in a simulation;

FIG. 4 is a graph showing a result of the simulation;

FIG. 5 is a side view illustrating an optical module according to a second embodiment;

FIG. 6 is a side view illustrating an optical module according to a third embodiment;

FIG. 7 is a side view illustrating an optical module according to a fourth embodiment;

FIG. 8 is a plan view illustrating a prior art optical module;

FIG. 9 is a side view illustrating the optical module shown in FIG. 8;

FIG. 10 is a plan view illustrating another prior art optical module;

FIG. 11 is a side view illustrating the optical module shown in FIG. 10; and

FIG. 12 is a side view illustrating another prior art optical module.

### DETAILED DESCRIPTION OF PREFERRED EMBODIMENTS

An optical module according to embodiments of the present invention will be described with reference to drawings.

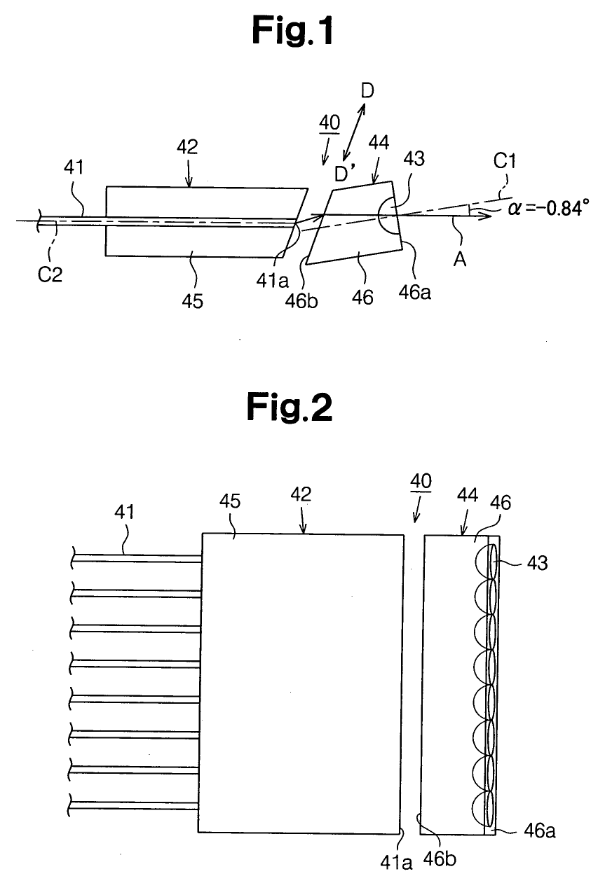

FIGS. 1 and 2 show an optical module 40 according to a first embodiment. The optical module 40 includes an optical fiber array 42, which has optical fibers (single mode optical fibers) 41, and a lens array 44, which has microlenses, which are microlenses 43 in the first embodiment. The optical module 40 is formed as a collimator array.

The optical fiber array 42 has a capillary 45, which retains optical fibers 41 as a unit. The lens array 44 is a flat microlens array that has a transparent lens substrate 46. The microlenses 43 are formed on a right end surface 46a (first end surface) of the lens substrate 46. The lens array 44 is arranged such that a left end surface 46b (second end surface) of the lens substrate 46 faces a fiber outgoing end surface 46a of the optical fiber array 42.

In the optical module 40, the fiber outgoing end surface 46a is polished to be inclined with respect to a central axis C2 of a core of the optical fiber 41. The left end surface 46b of the lens substrate 46 (a lens incoming end surface of the lens array 44) that faces the fiber outgoing end surface 46a is polished to be inclined with respect to an optical axis C1 of each microlens 43. The right end surface 46a of the lens substrate 46 is polished to be perpendicular to the optical axis C1 of the microlenses. The optical fiber array 42 and the lens array 44 are adjusted such that an angle α between an outgoing light A sent out from a lens outgoing end surface, which is the right end surface 46a of the lens substrate 46 in the first embodiment, and the optical axis C1 of the microlenses is optimal. Assume that when the outgoing light A is inclined lower than the optical axis C1 of the microlenses, the angle between the outgoing light A and the optical axis C1 is expressed by a negative value (−). In this case, the optimal angle is, for example, −0.84 degrees.

In the optical module 40, the fiber outgoing end surface 46a, the lens incoming end surface of the lens array 44, which is the left end surface 46b of the lens substrate 46, and the lens outgoing end surface, which is the right end surface 46a of the lens substrate 46, are inclined with respect to the central axis C2 of the core of the optical fiber 41.

That is, the inclination angle between the fiber outgoing end surface 46a and a surface that is perpendicular to the central axis C2 of the optical fiber differs from the inclination angle between the left end surface 46b of the lens substrate 46 and a surface that is perpendicular to the optical axis C1 of the microlenses by an absolute value (0.84 degrees) of the optimal angle. Since the left end surface 46b faces the fiber outgoing end surface 46a in parallel, the fiber outgoing end surface 46a, the left end surface 46b, and the right end surface 46a are all inclined with respect to the central axis C2 of the optical fiber. The lens array 44 is shifted in parallel with the fiber outgoing end surface 46a, or in a direction represented by an arrow DD′ in FIG. 1, such that the outgoing light A becomes parallel with the central axis C2 of the optical fiber. In the first embodiment, the lens array 44 is shifted in parallel with the fiber outgoing end surface 46a such that the outgoing light A becomes horizontal as viewed in FIG. 1. To check if the outgoing light A is horizontal, for example, an infrared sensor card, the color of which changes when an infrared light is irradiated, is used to measure the outgoing light A at two points at the same height. The inclination angle α of the outgoing light A with respect to the optical axis C1 of the microlenses will hereafter be referred to as a beam tilt angle.

In the first embodiment, the optimal angle of the beam tilt angle α is set to −0.84 degrees. The fiber outgoing end surface 46a of the optical fiber array 42 is polished to be inclined with respect to a surface that is perpendicular to the central axis C2 of the optical fiber by 8 degrees. The lens incoming end surface, which is the left end surface 46b of the lens substrate 46, is polished to be inclined with respect to a surface that is perpendicular to the optical axis C1 of the microlenses by 8.84 degrees.

The first embodiment provides the following advantages.

(a) The fiber outgoing end surface 46a and the lens incoming end surface, which is the left end surface 46b of the lens substrate 46, are each polished such that the fiber outgoing end surface 46a is inclined with respect to the central axis C2 of the optical fiber, and the left end surface 46b is inclined with respect to the optical axis C1 of the microlenses. The inclination angle of the fiber outgoing end surface 46a relative to central axis C2 and the inclination angle of left end surface 46b relative to optical axis C1 are different by 0.84 degrees. Since the left end surface 46b of the lens substrate 46 faces the fiber outgoing end surface 46a in parallel, the fiber outgoing end surface 46a, the left end surface 46b, and the right end surface 46a are all inclined with respect to the central axis C2 of the optical fiber. Accordingly, the reflected return light at the three surfaces are reduced. Therefore, the outgoing light A need not be inclined with respect to the central axis C2 of the optical fiber in order to reduce reflected return light at the lens outgoing end surface in the manner as the above mentioned prior art. Also, increase of an insertion loss caused by excessively tilting the outgoing light A with respect to the optical axis C1 of the microlenses is prevented.

(b) The insertion loss is decreased by adjusting the optical fiber array 42 and the lens array 44 such that the angle between the outgoing light A and the optical axis C1 of the microlenses (the beam tilt angle α) becomes the optimal angle (−0.84 degrees).

(c) The optical fiber array 42 and the lens array 44 are adjusted such that the outgoing light A becomes parallel with the central axis C2 of the optical fiber. Accordingly, the number of parts, adjusting procedures, and a space for mounting another optical part are reduced. Therefore, the optical module 40 reduces the reflected return light while reducing the number of parts, adjusting procedures, and a space for mounting another optical part, and reducing the insertion loss.

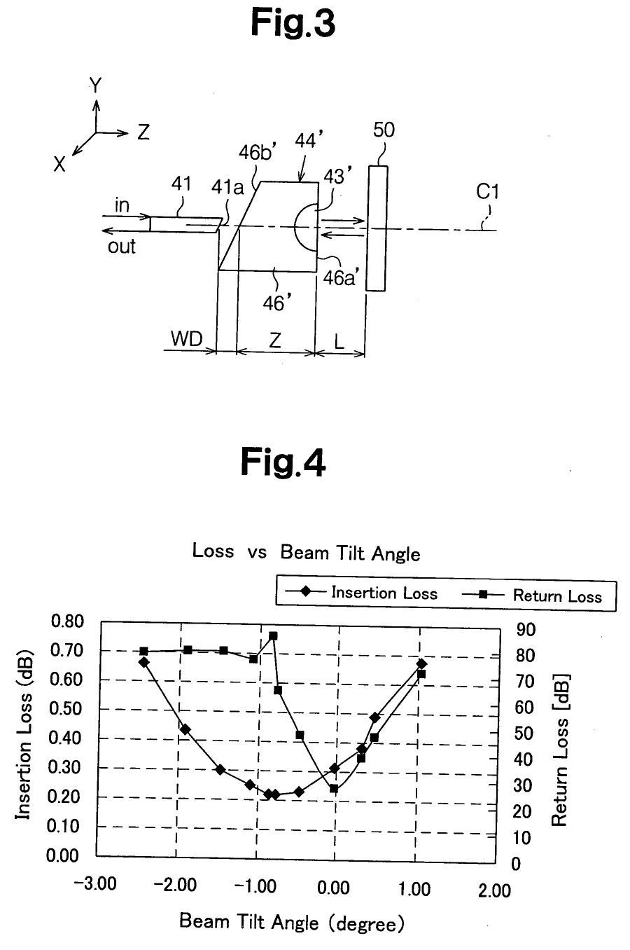

In an optical system shown in FIG. 3, an outgoing light from each optical fiber 41 is converted into a parallel beam by a corresponding one of microlenses 43′ of a lens array (flat microlens) 44′. The parallel beam then enters a mirror 50 and is reflected by the mirror 50. The reflected light is converged by the lens array 44′ and enters another optical fiber 41. In this case, the insertion loss (IL) is represented by the following equation.

Insertion Loss (dB)=10×Log (Incoming light Amount Pout/Outgoing light Pin)

(d) The lens array 44 is shifted parallel to the fiber outgoing end surface 46a, or in the DD′ direction, such that the outgoing light A becomes parallel with the central axis C2 of the optical fiber. That is, when the lens array 44 is shifted with respect to the optical fiber array 42 parallel to the fiber outgoing end surface 46a, or in the DD′ direction, the outgoing angle of the outgoing light A is varied. The position where the outgoing light A becomes parallel with the central axis C2 of the optical fiber is the optimal position of the lens array 44. This facilitates adjusting of the position of the lens array 44 with respect to the optical fiber array 42.

(e) In the optical module 40 that uses a flat microlens as the lens array 44, the reflected return light is reduced while reducing the number of parts, the adjusting procedures, and a space for mounting another optical part, and reducing the insertion loss.

(f) The beam tilt angle α is adjusted to be the optimal angle of −0.84 degrees. Therefore, the insertion loss is minimized, and the reflected return light is also minimized.

The beam tilt angle α, or the inclination angle of the outgoing light A with respect to the optical axis C1 of the microlenses, is changed, and the insertion loss and a return loss of each beam tilt angle α is calculated in the following simulation. As a result, the optimal result is obtained when the beam tilt angle is set to −0.84 degrees. That is, the insertion loss is minimum and the return loss is maximum (reflection return light is minimum) when the beam tilt angle is set to −0.84 degrees. The return loss (RL) is represented by the following equation.

Return loss (dB)=−10×Log (Outgoing Light Amount Pin/Amount Of Reflected Return Light P′ in)

In the above equation, Pin represents the outgoing light amount sent out from the optical fiber 41, P′ in represents the amount of reflected return light returned to the optical fiber 41 after being reflected by the above mentioned three surfaces.

The simulation was performed using the optical system shown in FIG. 3 under the following conditions with the following calculation method.

Conditions

(1) The numerical aperture of the optical fiber 41 was 0.10 (wave length: 1550 nm), and the inclination angle of the fiber outgoing end surface 46a was 8 degrees.

(2) The refractive index n of a lens substrate 46′ of the flat microlens array (lens array 44′) was 1.523, the thickness Z of the lens substrate 46′ on the light path was approximately 1 mm, the working distance WD was 0.100 (mm), the inclination angle of a lens incoming end surface 46b′ was 8 degrees, and the lens diameter of each microlens 43′ was 250 μm.

Calculation Method

(1) In the optical system shown in FIG. 3, the distance L between the lens array 44′ and the mirror 50 was 1 mm. The offset amount (SMF-offset(Y)(mm)) of the optical fiber 41 with respect to the optical axis C1 of the microlenses and the inclination angle (Mirror-tilt(degree)) of the mirror 50 with respect to the optical axis C1 of the microlenses were adjusted such that the insertion loss (IL(dB)) was minimized. Then, the insertion loss was calculated. The inclination angle of the mirror 50 was adjusted only when calculating the insertion loss.

(2) In a state where the insertion loss calculated as described above was optimal, the amount of the reflected return light (P′ in) from a lens outgoing end surface 46a′ of the lens substrate 46′ to the optical fiber 41 was calculated. The return loss (RL(dB)) was then calculated using the above equation. An antireflection film was formed on the lens outgoing end surface 46a′. The reflectivity of the lens outgoing end surface 46a′ was 0.2%.

(3) The beam tilt angle α, or the inclination of the outgoing light A from the lens incoming end surface 46b′ with respect to the optical axis C1 of the microlenses was varied, and the calculations (1) and (2) are repeatedly performed on each beam tilt angle α to obtain the insertion loss and the return loss. The result is shown in the following Table 1 and a graph of FIG. 4.

TABLE 1

| SMF-offset (Y) | Beam Tilt | WD | IL | Mirror-tilt | RL | |
|---|---|---|---|---|---|---|
| (mm) | Angle (°) | (mm) | (dB) | (°) | (dB) | |
| −0.019 | 1.05 | 0.069 | 0.67 | 1.05 | 71.7 | |
| −0.012 | 0.49 | 0.070 | 0.48 | 0.49 | 47.1 | |
| −0.010 | 0.34 | 0.071 | 0.38 | 0.34 | 39.0 | |
| −0.006 | 0.00 | 0.071 | 0.31 | 0.00 | 27.5 | |
| 0.000 | −0.45 | 0.072 | 0.23 | −0.45 | 47.4 | |
| 0.004 | −0.74 | 0.073 | 0.22 | −0.74 | 64.5 | |
| 0.005 | −0.84 | 0.073 | 0.22 | −0.84 | 84.8 | [symbol] Best |
| 0.008 | −1.07 | 0.073 | 0.25 | −1.07 | 76.5 | Position |
| 0.013 | −1.46 | 0.073 | 0.30 | −1.46 | 79.4 | |
| 0.019 | −1.93 | 0.073 | 0.44 | −1.93 | 79.3 | |
| 0.026 | −2.47 | 0.073 | 0.66 | −2.47 | 78.7 | |

As a result of the above simulation, as shown in Table 1 and FIG. 4, when the beam tilt angle α is −0.84, the insertion loss is minimum and the return loss is maximum (the reflected return light is minimum).

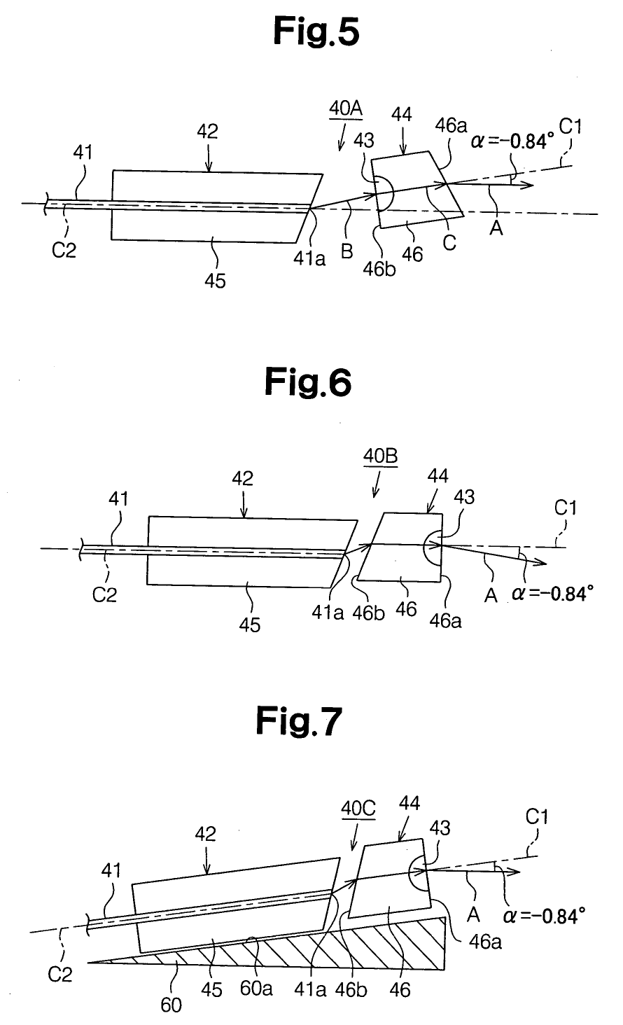

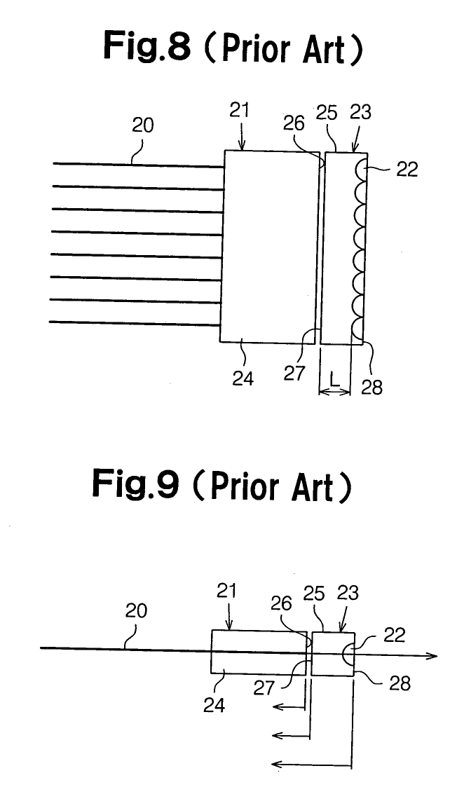

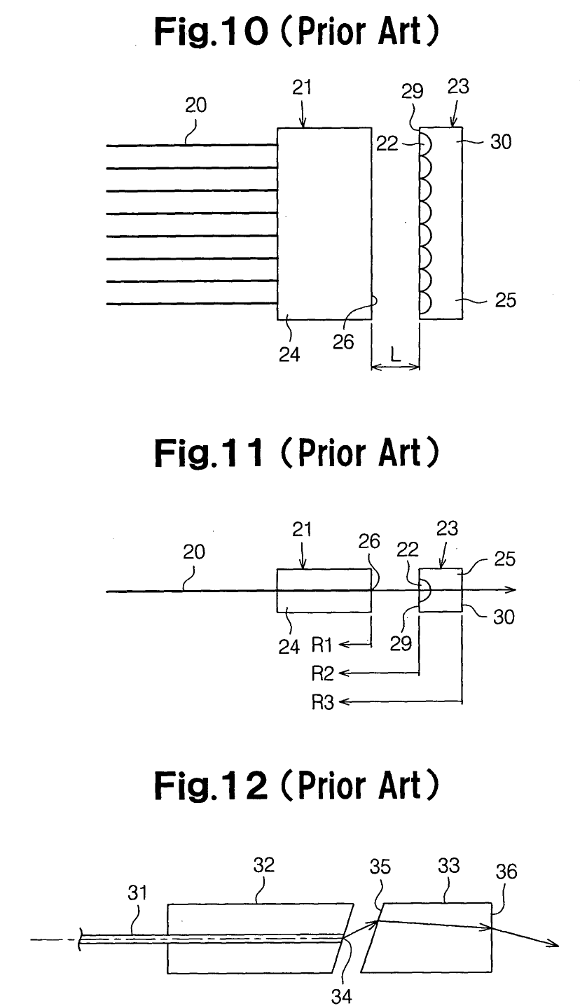

FIG. 5 shows an optical module 40A according to a second embodiment. The optical module 40A includes the lens array 44, which is formed by a flat microlens array. The left end surface 46b of the lens substrate 46 of the lens array 44 faces the fiber outgoing end surface 46a. The fiber outgoing end surface 46a and the right end surface 46a of the lens substrate 46 are polished to be inclined with respect to the axes C2 and C1, respectively, at different angles. The inclination angle of the optical axis C1 of the microlenses with respect to the central axis C2 of the optical fiber is adjusted such that the outgoing light A from the right end surface 46a of the lens substrate 46 becomes parallel with the central axis C2 of the optical fiber, or such that the outgoing light A from the right end surface 46a of the lens substrate 46 becomes horizontal as viewed in FIG. 5. That is, when the lens array 44 is shifted with respect to the optical fiber array 42 in parallel with the fiber outgoing end surface 46a, the outgoing angle of the outgoing light A varies. The position where the outgoing light A becomes parallel with the central axis C2 of the optical fiber is the optimal position of the lens array 44. To check whether the outgoing light A is horizontal, an infrared sensor is used to measure the outgoing light A at two points at the same height in the same manner as the first embodiment.

In the second embodiment, for example, the fiber outgoing end surface 46a is polished to be inclined with respect to a surface that is perpendicular to the central axis C2 of the optical fiber by 8 degrees. The lens outgoing end surface, which is the right end surface 46a of the lens substrate 46 is polished to be inclined with respect to a surface that is perpendicular to the optical axis C1 of the microlenses by 1.46 degrees. The lens incoming end surface, which is the left end surface 46b of the lens substrate 46, is inclined with respect to a surface that is perpendicular to the central axis C2 of the optical fiber by 2.78 degrees. The lens outgoing end surface, which is the right end surface 46a of the lens substrate 46, is inclined with respect to a surface that is perpendicular to the central axis C2 of the optical fiber by 4.24 degrees. Accordingly, the left end surface 46b of the lens substrate 46 faces the fiber outgoing end surface 46a at a predetermined angle. Thus, the three surfaces are inclined with respect to the central axis C2 of the optical fiber. Therefore, the angle between a beam B and the central axis C2 of the optical fiber is 3.78 degrees, the angle between a beam C and the central axis C2 of the optical fiber is 2.78 degrees, and the angle between a beam (outgoing light) A and the central axis C2 of the optical fiber is zero degrees.

The second embodiment provides the following advantages.

(g) The fiber outgoing end surface 46a and the lens outgoing end surface, which is the right end surface 46a of the lens substrate 46 are polished at different angles, and the lens incoming end surface, which is the left end surface 46b of the lens substrate 46 is polished to be perpendicular to the optical axis C1 of the microlenses. The left end surface 46b faces the fiber outgoing end surface 46a at the predetermined angle. Therefore, the three surfaces 46a, 46a, and 46b are inclined with respect to the central axis C2 of the optical fiber. Accordingly, the reflection return light at each surface 46a, 46a, or 46b is reduced.

(h) The lens array 44 is shifted in parallel with the fiber outgoing end surface 46a such that the outgoing light A becomes parallel with the central axis C2 of the optical fiber. This facilitates adjusting of the lens array 44 with respect to the optical fiber array 42.

(i) The lens array 44 is shifted with respect to the optical fiber array 42 in parallel with the fiber outgoing end surface 46a such that the outgoing light A becomes parallel with the central axis C2 of the optical fiber. This varies the outgoing angle of the outgoing light A. Accordingly, the lens array 44 is adjusted to the optimal position where the outgoing light A becomes parallel with the central axis C2 of the optical fiber.

(j) The flat microlens array (lens array 44) is arranged such that the left end surface 46b of the lens substrate 46 faces the fiber outgoing end surface 46a. Therefore, the reflected return light is reduced while reducing the number of parts, adjusting procedures, and a space for mounting another optical part and reducing the insertion loss.

FIG. 6 shows an optical module 40B according to a third embodiment. The optical module 40B includes the optical fiber array 42 and the lens array 44 in the same manner as the first embodiment shown in FIGS. 1 and 2.

In the optical module 40B, the fiber outgoing end surface 46a and the lens incoming end surface, which is the left end surface 46b of the lens substrate 46, are polished to be inclined with respect to the central axis C2 of the optical fiber at the same angle. The left end surface 46b faces the fiber outgoing end surface 46a in parallel. The angle (beam tilt angle α) of the outgoing light A with respect to the optical axis C1 of the microlenses is adjusted to the optimal angle (−0.84 degrees) by shifting the lens array 44 in parallel with the fiber outgoing end surface 46a.

The third embodiment provides the following advantages.

(k) The reflection return light at the fiber outgoing end surface 46a and the left end surface 46b is reduced.

(l) The beam tilt angle α is adjusted to the optimal angle by shifting the lens array 44 in parallel with the fiber outgoing end surface 46a. Accordingly, the insertion loss is reduced. Therefore, the reflection return light is reduced while reducing the insertion loss.

FIG. 7 shows an optical module 40C according to a fourth embodiment. The optical module 40C has the same structure as the optical module 40B shown in FIG. 6 except that the optical fiber array 42 and the lens array 44 are secured on an inclined surface 60a of a wedge spacer 60 such that the outgoing light A from the lens outgoing end surface, which is the right end surface 46a of the lens substrate 46, is horizontal as viewed in FIG. 7. The wedge spacer 60 corresponds to an angle compensating member, which retains the optical fiber array 42 and the lens array 44 to be inclined with respect to a horizontal surface or a reference surface, such as a surface plate. To check whether the outgoing light A is horizontal, the above mentioned infrared sensor is used to measure the outgoing light A at two points at the same height.

The fourth embodiment provides the following advantages.

(m) Since the outgoing light A from the right end surface 46a of the lens substrate 46 is horizontal, the reflection return light is reduced.

It should be apparent to those skilled in the art that the present invention may be embodied in many other specific forms without departing from the spirit or scope of the invention. Particularly, it should be understood that the invention may be embodied in the following forms.

In the above embodiments, the optical module includes the optical fiber array 42, which has the optical fibers 41, and the lens array 44, which has the microlenses 43. However, the present invention is not limited to have such structure, but may widely be applied to a collimator or a collimator array that includes an optical fiber array, which has at least one optical fiber, and a lens array, which has at least one microlens. For example, the present invention may be applied to a collimator (single collimator) that includes a single core capillary, which has an optical fiber, and a microlens.

In the above embodiments, the lens array 44 is formed by the flat microlens array in which the microlenses 43 are arranged in a line. However, the present invention may be applied to the lens array 44, which is formed by the flat microlens array, in which the microlenses 43 are arranged in two dimensions.

In the above embodiments, the lens array 44 is formed by the flat microlens array on which microlenses, which are microlenses, are located. However, the present invention may be applied to a lens array that has at least one microlens, which is a gradient index rod lens.

In the above embodiments, the numerical value of each part is an example and can be changed as required.

In the first embodiment, the lens array 44 is constituted by the flat microlens array in which the microlenses 43 are formed on the lens substrate 46 by an ion-exchange method. However, the present invention is not limited to have such structure, but several types of microlenses may be used. For example, after forming a lenticular resin layer on a glass, a lens array may be manufactured by reactive ion etching (RIE) method using anisotropic etching, or a resin lens array may be manufactured by molding. The lens array 44 may be formed by arranging microlenses, which are gradient index rod lenses.

In the fourth embodiment, the wedge space 60 is used. However, the present invention need not use the wedge spacer 60, but may use any member that can retain the optical fiber array 42 and the lens array 44 in an inclined state with respect to a horizontal surface, or a reference surface, such as a surface plate.

The present examples and embodiments are to be considered as illustrative and not restrictive and the invention is not to be limited to the details given herein, but may be modified within the scope and equivalence of the appended claims.

1. An optical module comprising:
an optical fiber array, wherein the optical fiber array has at least one optical fiber, wherein the optical fiber array includes an outgoing end surface, and wherein the optical fiber includes a central axis of the optical fiber; and
a lens array, wherein the lens array has at least one microlens, wherein the lens array includes an incoming end surface, which faces the outgoing end surface of the optical fiber array, and an outgoing end surface, which sends out a light that is transmitted through the microlens, and wherein the microlens has an optical axis,
wherein the outgoing end surface of the optical fiber array is formed to be inclined with respect to the central axis of the optical fiber, wherein the incoming end surface of the lens array is formed to be inclined with respect to the optical axis of the microlens, and wherein the relative position of the optical fiber array and the lens array is adjusted such that an inclination angle of the outgoing light sent out from the outgoing end surface of the lens array with respect to the optical axis of the microlens becomes an optimal angle.

2. The optical module according to claim 1, wherein three surfaces, which include the outgoing end surface of the optical fiber array, the incoming end surface of the lens array, and the outgoing end surface of the lens array, are inclined with respect to the central axis of the optical fiber, and wherein the relative position of the optical fiber array and the lens array is adjusted such that the outgoing light becomes parallel with the central axis of the optical fiber

3. The optical module according to claim 2, wherein the outgoing end surface of the optical fiber array and the incoming end surface of the lens array are arranged to be inclined with respect to the central axis of the optical fiber by an angle that is equivalent to the optimal angle, wherein the incoming end surface of the lens array is arranged to face the outgoing end surface of the optical fiber array in parallel, wherein the three surfaces are inclined with respect to the central axis of the optical fiber, and wherein the outgoing light is made parallel with the central axis of the optical fiber by shifting the lens array in parallel with the outgoing end surface of the optical fiber array.

4. The optical module according to claim 2, wherein the lens array includes a transparent lens substrate, wherein the lens substrate has a first end surface and a second end surface, which are on opposite sides of the lens substrate, wherein the microlens is located on the first end surface, and wherein the second end surface forms the incoming end surface of the lens array.

5. The optical module according to claim 1, wherein the outgoing end surface of the optical fiber array and the outgoing end surface of the lens array are inclined with respect to the central axis of the optical fiber by different angles, wherein the incoming end surface of the lens array is arranged perpendicular to the optical axis of the microlens, and wherein the three surfaces are inclined with respect to the central axis of the optical fiber by placing the incoming end surface of the lens array at a predetermined angle with respect to the outgoing end surface of the optical fiber array.

6. The optical module according to claim 5, wherein the lens array includes a transparent lens substrate, wherein the microlens is located on a first end surface of the lens substrate, and wherein the first end surface of the lens substrate serves as the incoming end surface of the lens array.

7. The optical module according to claim 1, wherein the outgoing end surface of the optical fiber array and the incoming end surface of the lens array are inclined by the same angle, wherein the outgoing end surface of the lens array is arranged perpendicular to the optical axis, wherein the incoming end surface of the lens array faces the outgoing end surface of the optical fiber array in parallel, and wherein the inclination angle of the outgoing light with respect to the optical axis of the microlens is maintained at the optimal angle by shifting the lens array in parallel with the outgoing end surface of the optical fiber array.

8. The optical module according to claim 7, wherein the optical module includes an angle compensating member, which retains the optical fiber array and the lens array to be inclined with a horizontal surface such that the outgoing light becomes horizontal.

9. The optical module according to claim 1, wherein the optimal angle is substantially −0.84 degrees, wherein when the outgoing light is inclined lower than the optical axis of the microlens, the angle between the outgoing light and the optical axis of the microlens is expressed by a negative value.

10. An optical module comprising:
an optical fiber array, wherein the optical fiber array has a plurality of optical fibers, which are arranged perpendicular to each other at predetermined intervals, and a capillary, which supports the optical fibers, wherein the optical fiber array includes an outgoing end surface, and wherein each optical fiber includes a central axis;
a lens array, wherein the lens array has a plurality of microlenses, wherein each microlens corresponds to one of the optical fibers, wherein the lens array includes an incoming end surface, which faces the outgoing end surface of the optical fiber array, and an outgoing end surface, which sends out light that is transmitted through the microlens, and wherein each microlens has an optical axis,
wherein the outgoing end surface of the optical fiber array is formed to be inclined with respect to the central axis of each optical fiber, wherein the incoming end surface of the lens array is formed to be inclined with respect to the optical axis of each microlens, and wherein the relative position of the optical fiber array and the lens array is adjusted such that the inclination angle of the outgoing light sent out from the outgoing end surface of the lens array with respect to the optical axis of each microlens becomes an optimal angle.

11. The optical module according to claim 10, wherein three surfaces, which include the outgoing end surface of the optical fiber array, the incoming end surface of the lens array, and the outgoing end surface of the lens array, are inclined with respect to the central axis of each optical fiber, and wherein the relative position of the optical fiber array and the lens array is adjusted such that the outgoing light becomes parallel with the optical axis of each microlens.

12. The optical module according to claim 11, wherein the outgoing end surface of the optical fiber array and the incoming end surface of the lens array are arranged to be inclined with respect to the central axis of the optical fiber by an angle that is equivalent to the optimal angle, wherein the incoming end surface of the lens array is arranged to face the outgoing end surface of the optical fiber array in parallel, wherein the three surfaces are inclined with respect to the central axis of each optical fiber, and wherein the outgoing light is made parallel with the central axis of each optical fiber by shifting the lens array in parallel with the outgoing end surface of the optical fiber array.

13. The optical module according to claim 11, wherein the lens array includes a transparent lens substrate, wherein the lens substrate has a first end surface and a second end surface, which are on opposite sides of the lens substrate, wherein the microlenses are located on the first end surface, and wherein the second end surface forms the incoming end surface of the lens array.

14. The optical module according to claim 10, wherein the outgoing end surface of the optical fiber array and the outgoing end surface of the lens array are inclined with respect to the central axis of the optical fiber by different angles, wherein the incoming end surface of the lens array is arranged perpendicular to the optical axis of each microlens, and wherein the three surfaces are inclined with respect to the central axis of each optical fiber by placing the incoming end surface of the lens array at a predetermined angle with respect to the outgoing end surface of the optical fiber array.
